(19) United States
(12) Patent Application Publication
(10) Pub. No.: US 2009/0202812 A1
(43) Pub. Date: Aug. 13, 2009

(54) METHOD FOR PRODUCTION OF COMPOSITE BODIES AND COMPOSITE BODIES PRODUCED THEREBY

(75) Inventors: Peter Schaeffler, Taching (DE); Eric Wolfsgruber, Braunau am Inn (AT)

Correspondence Address: ROBERTS MLOTKOWSKI SAFRAN & COLE, P.C.;Intellectual Property Department, P.O. Box 10064, MCLEAN, VA, 22102-8064, US

(73) Assignee: ALULIGHT INTERNATIONAL GMBH, Ranshofen (AT)

(21) Appl. No.: 12/299,541

(22) PCT Filed: Apr. 4, 2007
(86) PCT No.: PCT/EP2007/003068

§ 371 Date: Nov. 12, 2008

(30) Foreign Application Priority Data
May 4, 2006 (DE) 10 2006 020 860.9

(51) Int. Cl. B32B 5/20; B22F 7/02

(52) U.S. Cl. 428/312.2; 264/42

(57) ABSTRACT

A method for producing composite bodies having at least one outer layer of a non-foaming powder and a metal foam layer. In one embodiment, the powder layers are rolled separately from one another, then the rolled parts are put one over the other in a predetermined number of rolled powder layers; optionally, they are rolled together again, and thereafter, the metal foam layer is foamed by heating to produce a layer arrangement. Alternatively, the powder layers are formed one on top of the other to form a layer arrangement that is then rolled prior to foaming.

### BACKGROUND OF THE INVENTION

1. Field of the Invention

The invention relates to a method for production of composite bodies with at least one outer layer and a metal foam layer and composite bodies produced thereby. The invention relates especially to a powder-metallurgic method.

2. Description of Related Art

The expressions used here in the field of powder metallurgy correspond to the definitions of the following reference books: Schatt: Pulvermetallurgie, VDI-Verlag 1994, Düsseldorf; R. M. German: Powder Metallurgy Science, Metal Powder Industries Federation, Princeton, N.J., USA 1989, which are referred to the full extent in order to avoid repetitions.

Composite bodies having at least one porous metal core and outer layers made of massive metal are of great importance for many technical applications because they have superior mechanical and chemical characteristics at a low weight. Also, in comparison with materials of porous metallic basic material they have the big advantage that external forces apply on the outer layer of a body equipped with outer layers; by arranging elastic outer layer material or hard outer layer material, the danger of irreversible damages of the foam body caused by force exposure can be avoided.

The composite bodies are preferably to be used as strong but light construction materials. This kind of light building materials is used in the construction industry as facing elements and load-bearing elements of low weight; and in the motor vehicle industry, like aeronautics, motor vehicles and ship construction in form of insulation boards or protection boards against mechanical or thermal exposure (fire-resistant elements). By providing a lacquer outer layer, a pleasant external appearance can also be achieved.

Until now, this type of composite bodies was produced by connecting metal sheets with metal foam inner layers, for example, by adhesive bonding, soldering or welding between the outer layers and the porous core. Aluminum foam plates connected on both sides or on one side by aluminum or steel plates are well known.

However, the disadvantage of these compositions is that only surface layers of metal sheets could be processed which had to be costly prepared, cut, cleaned and produced with special handling machines for metal sheets. This handling of metal sheet material limits very much the choice of available outer layer materials and hinders a continuous process management.

### SUMMARY OF THE INVENTION

As a consequence of the foregoing, it is the object of the invention to overcome the disadvantages of the prior art.

This object is solved by the features of the method described below.

In one embodiment, the powder layers are rolled separately one from another, then the rolled parts are put one over the other in a predetermined number of rolled powder layers; optionally, they are rolled together again, and thereafter, foamed by heating to produce a layer arrangement. This is primarily suitable if, for the powder rolling of the different layers, different forming pressures, different atmospheres or other temperatures are needed.

Preferably, the production of the rolled powder layers is executed in forms, whereby a pre-cut part of the powder rolled materials is achieved. These forms can by heated for the production of rolled powder layers.

Between at least one powder layer of the outer layer material and the foamable powder layer, at least one powder or film-shaped binding intermediate layer can be introduced to optimize the connection if there are binding problems. A binding means can be selected from the group consisting of brazing material, flux material, and anti-oxidation materials.

It is also possible to put the powders directly one layer over the others:
By producing an outer layer powder layer;
By applying a foam powder mixture layer on the outer layer powder layer;
By producing an outer layer powder layer of the same or of a different material than the material of the outer layer powder layer on the foam powder layer;
By rolling the powder layers all together;
By heating the rolled powder layers when foaming the foam powder mixture layer and by bonding the outer layer powder layers.

This is suitable for coatings which do not have to form a leak-proof surface or a surface that is uniformly strong.

Typical outer layer powders can be selected from the group consisting of: metals, metal oxides, colors, ceramic powders, and if necessary by adding compacting additives or lubricants. Optionally, in many powders, the addition of compacting additives like wax or graphite can improve the rollability.

In another embodiment, aluminum powder with alloy additions or pre-alloyed aluminum alloy powder, optionally with compacting additives, can be used.

For the optimization of the mechanical characteristics and the tensile strength, a net, filament, fibers or hard components are rolled into at least one powder. It can also make sense to roll at least one layer when heated. In connection with the present invention, in this case, the term powder is intended to include also granules or cuttings.

A particular advantage of the method according to the invention is that it can be executed in a continuous or semi-continuous way by maintaining an essentially continuous product. Thereby costs for tools arising if you have to prepare different tools for products of different lengths can be avoided to permit a higher flexibility for production concerns.

A composite body according to the present invention comprises at least one metal foam layer and at least one power metallic outer layer wherein there is a metallic, chemical or mechanical bonding between the metal foam and the powder metal outer layer/layers.

For metallic and/or mechanic bonding between the layers of the composite body connected one with another, a good bonding without a costly adhesive or brazing procedure can be achieved. In contrast to the prior use of sheet plates, handling steps and material limits can be avoided. In this way, according to the present invention, a layer with a low coefficient of friction can be applied on the foam—for example, by arranging consolidated lubricants in the outer layer or a hard abrasion layer—by mixing hard materials, like wolfram carbide, silicon carbide, etc., or a pure bonding layer, by producing the outer layer of a bondable material which permits, for example, the chemical bonding of additional layers.

As foamable materials, base metals and their alloys or compositions, like Zn, Ni, Al, Mg, Ca, Ni, Fe, Sn and primarily their alloys and composites are used. Typical oxidizable metal alloys are Mg, Ca, Al, Zn, Fe, Sn—even if not restricted to them. It is possible to foam under a normal atmosphere, but this causes thicker walls of the pores, bigger pores, and in general, a lower porosity level than if there is a protective atmosphere. The economically priced variant of normal atmosphere, because of the saving of expensive gasses, should preferably be used with metals that are not particularly oxidable, as for certain aluminum alloys. For the production of aluminum foam parts, the following mixtures are suitable for the production of the foam: aluminum powder and also a metal hydride as a blowing agent in the range of between 0.2-1.5 wt. %, optionally Si (0-50 wt. %, preferably 0-40 wt. %), optionally magnesium (0-3% wt. %) and optionally Cu (0-1 wt. %), optionally with other materials, like compacting additives. The foaming can be executed with the best advantage by using foamable materials with a melting point over 200° C., preferably over 300° C. and also with melting points over 500° C.

Blowing agents are for instance metal hydrides like TiH₂, ZrH2₂, MgH₂, but also carbonates, nitrides, hydrogen carbonates, and mixtures of oxides with carbon, as known to the person skilled in the art. These materials can also be inserted into the form or into the form in combination with strengthening elements like nets, filaments, threads and covering films.

The metallic material according to the present invention is produced by powder rolling, which is a continuous process. Thereby can be achieved a rapid and efficient production.

The production of a composite body with metal foam according to the present invention has the following process elements:

Metal foam layer material: Mixture of one or more metal powders, granules or cuttings, and optionally alloy additions, with one or more blowing agents and optionally one or more structure changing agents like hard materials or fibers. Compaction of the powder mixture by cold rolling or warm rolling (under the foaming temperature, so that there is no foaming). Optionally, a compacting additive in a quantity under 5 wt. % can be mixed with it in order to facilitate the compaction during the rolling.

Outer layer: Production of outer layer powder layers made of powders, granules or cuttings of a suitable grain size and grain size distribution, like by: selection of a metallic or ceramic powder or by the mixture of metallic or metal alloy powders with alloy additions—or by the mixture of ceramic powder, optionally with structure changing agents, like hard elements, fibers or powders conferring optical characteristics, like pigments, highly reflecting materials or self-lubricating materials. A pressing agent in the usual quantity of under 5 wt. % can be added.

Bonding layer: As an intermediate bonding layer, a powdery brazing material, welding additive or flux materials having the suitable grain size or as film-shaped material can be used.

Thereafter, the composite body can be produced by separate rolling of the different layers, wherein cold-rolling and warm rolling can be applied, by the arrangement of the so rolled powder single layers one on another in the desired arrangement, optionally by joint rolling of this powder layer sequence and by subsequent heat treatment for foaming the metal foam.

According to the choice of the material, the powders after having arranged them one on the other, optionally by intermediate application of bonding or adhesive or separation layers, can be rolled together. Optionally a surface treatment of a powder rolled layer, can be performed, whereto mechanical and chemical treatments like grinding, sand blasting, etching, degreasing, impregnating, etc. are suitable

Thereafter, the foaming of the compound made of the foamable semi-finished product can be executed by heating to a temperature which is high enough to produce a volume expansion and as a consequence a creation of pores in the foamable material.

The process described above can be executed continuously, semi-continuously or discontinuously. Especially in an additional station continuously a powder metallurgic outer layer compound which for example can be constantly supplied by a powder rolling equipment can be applied with a foamable metal powder mixture or with an already rolled foamable layer. The necessary foaming step can also be executed on a continuous basis, for example in a continuous furnace or through an induction station.

Preferred embodiments of the present invention are now explained in detail with reference to the accompanying drawings.

### SUMMARY OF THE INVENTION

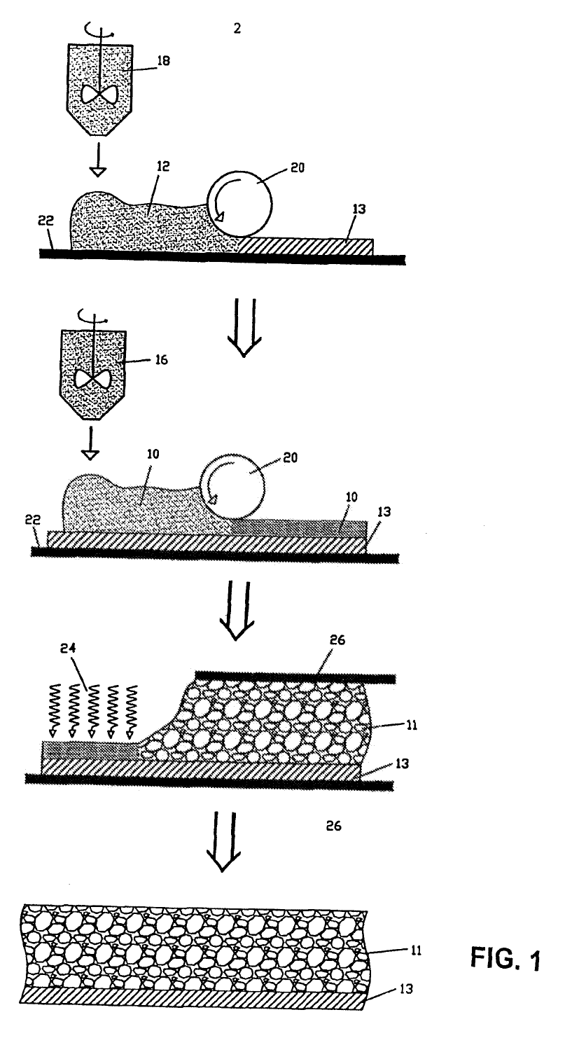

FIG. 1 shows a production method,

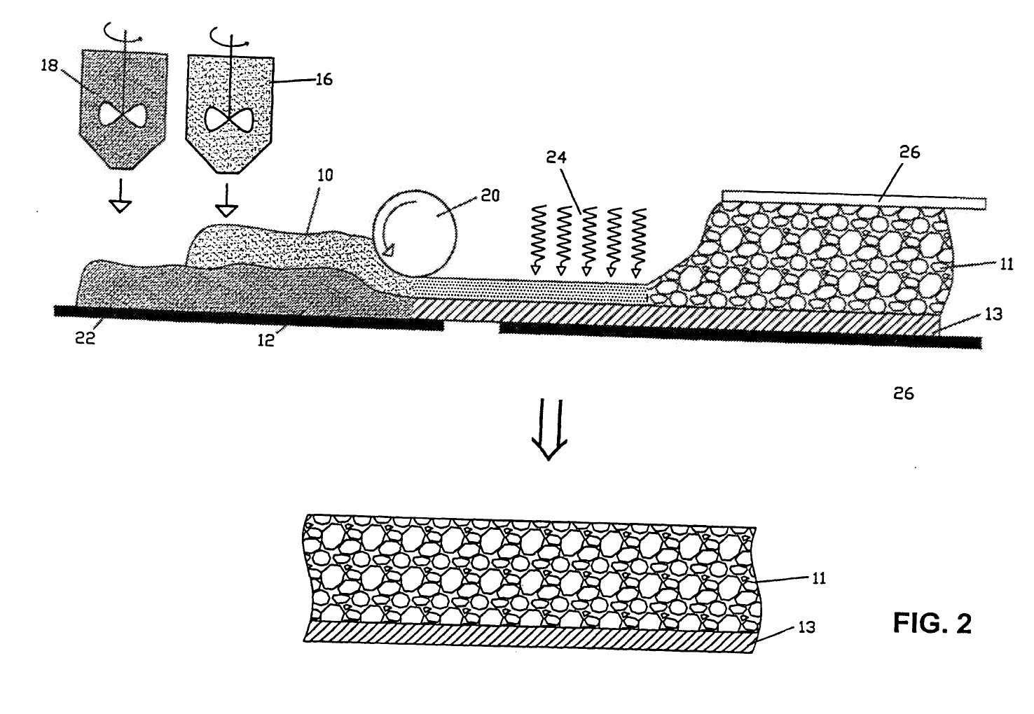

FIG. 2 shows an alternative production method,

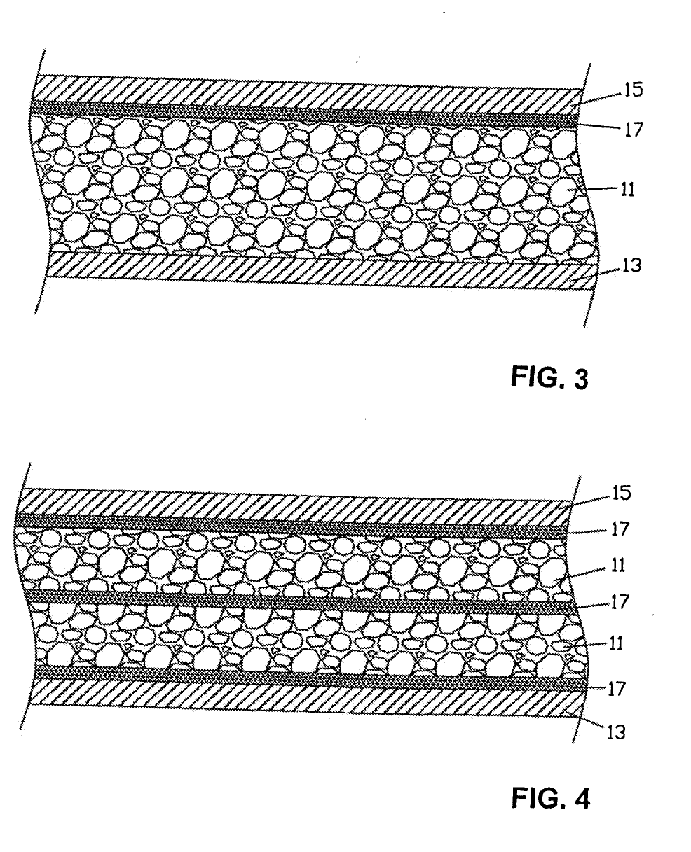

FIG. 3 shows a composite body produced by the method of the present invention,

FIG. 4 shows another composite body produced by the method of the present invention,

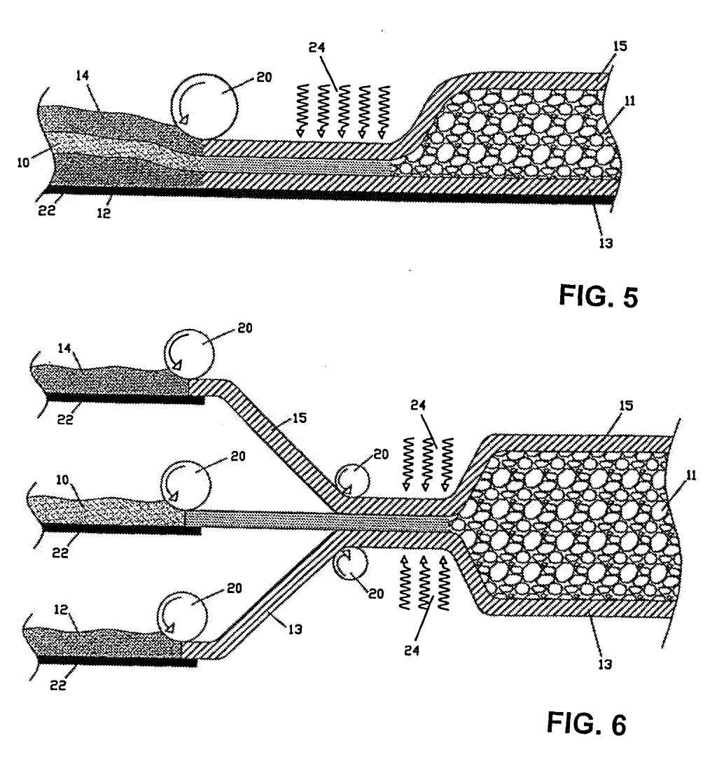

FIG. 5 shows the production of a composite body with metal foam and two powder outer layers by joint rolling, and

FIG. 6 shows the production of a composite body with metal foam and two powder outer layers by separate rolling of the single layers and the joint rolling of them.

### DETAILED DESCRIPTION OF THE INVENTION

FIG. 1 is the schematic representation of a production method for a composite body with one outer layer. Of course, more layers and outer layers can be arranged, but for the sake of clarity only a composition of two layers is presented, from which the person skilled in the art can recognize that additional method steps to arrange other layers in a similar way are applicable.

In the method of FIG. 1, first of all, shaped outer layer material is produced, preferably in a form 22. By means of a feeder in which the outer layer material, which should, in this case, be a material mixture (although this is not compulsory, because pure material can be used as well) is contained; the outer layer powder 12 is put into a form 22. Thereafter, in this form, the outer layer powder 12 is compacted by a rolling device 20 to produce a powder metallurgic outer layer 13. The resulting compacted powder outer layer 13, in another station, is supplied with a powder layer made of foamable material 10 from a feeder in which the foamable material is mixed with a blowing agent. This layer is compacted by an additional rolling device 20 into a foamable layer 10, preferably in a form 22. In the next step, a foaming form 26 that is sufficiently resistant to the foamable material is used in order to obtain a composite body which is similar to the final shape. However, it can also be foamed without form 26, but with the consequence of respective post processing steps like cutting. The rolled layer material now runs through a heating station 24, which dispenses enough heat to foam the foamable material so that it conforms at least partially to the foaming form 26. In this context, the heat exposure can also be carried out by means of emitters through diathermic shape surfaces. By the foaming method, mechanical and chemical bonds are produced between the foam and the outer layer material 13. In order to optimize the bonding, brazing or welding auxiliary materials can be applied on the outer layer powder layer or on the layer made of foamable material (not shown). By the respective sequence of suitable processing stations, a continuous operation is achievable having high level savings of processing steps and work for the production of coated foams.

In this method, different rolling conditions for the different layers can be used—for example, the outer layer can by rolled with a higher temperature and a higher pressure to achieve a high level of compaction, a higher level of hardness, tensile strength and density for the production of a mechanically loadable powder metallurgic layer, whereas the foamable material can be compacted under moderate conditions to avoid the decomposition of the blowing agent before the foaming.

In FIG. 2 a further embodiment of the process of the invention is shown.

In this case, on a form 22, through sequentially arranged feeders 18, 16, a layer of foamable material 10 is produced on an outer layer powder layer 12. Optionally, a separating material or alloys, which decompose with exposure to heat, may be used. The two powder layers are rolled together and compacted by a rolling device 20. The so compacted powder layers are foamed in a heating station 24 and using a foaming form 26. This method is primarily suitable if a high level of compaction of the outer layer is not needed, for example, for the optional connection of ceramic particles and similar hardening components to increase the hardness of the surface of the composite body layer. It can also be used if the rolling conditions are suitable for both layers.

A typical composite body as formed by the above methods is shown in FIG. 3. There, a metal foam 11 is covered on the under side by a second outer layer material 13 whereas its upper side is covered by a bonding layer 17 which connects the foam 11 with a first outer layer material layer 15. These embodiments are suitable if an outer layer material does adhere well to the foam surface, but it should be used because of its characteristics wherein these characteristics are not needed on both sides of the foam body. Suitable materials and methods are described in DE 10313321 A1 and corresponding to U.S. patent application No. 2007/0158877, which is incorporated herein by reference.

FIG. 5 schematically displays the production of a composite body with metal foam 11 and two outer layers 13, 15 made of powder by common rolling. In this case, the first outer layer powder 12, the powder mixture for the foamable material, for example, a metal powder and blowing agent, and the second outer layer powder are arranged one on the other, and then, the powders are compacted by the rolling device 20. After being rolled, the layer body is thermally foamed in a heating station 24, and a composite body is produced of the compacted outer layers 13, 15 and the metal foam 11 arranged between them, a good connection being established between the outer layers and the foam during the rolling step and during the foaming.

In FIG. 6 the production of a composite body with metal foam and two outer layers made of powder by separate rolling of the individual layers and their common rolling is shown. First of all, the powders of the first and second outer layer and the foamable metal powder mixture are separately compacted, optionally with a suitable binding agent, that is known to the person skilled in the art, to obtain compacted powder layers which can be arranged one on the other and then rolled in the next process step. These layers that have been rolled together can now have the foaming material thermally foamed, expanding the foaming material while the outer layers that were compacted during the rolling process remain dense.

In addition, the present invention is explained in detail in the following examples:

### EXAMPLE 1

Pure aluminum powder is layered onto a form and compacted by rolling. On this layer that has been compacted by rolling, a powder mixture of foamable material having the general composition AlMg₁Si₁₄ is applied and this layer sequence is rolled. The so produced composite is transferred to a foaming form that has at least one diathermic surface and heated inside by a heater 20 for foaming. A near finally formed composite body of an aluminum foam layer with a compacted aluminum powder layer is produced.

### EXAMPLE 2

Aluminum powder is mixed with 1 wt. % Cu, 2 wt. % Mg, 15 wt. % Si and 0.6 wt. % Titanum hydride powder to obtain a foamable material.

Aluminum oxide powder is mixed with compacting additives and is rolled in a form to obtain a first layer. On this layer, a layer of foamable material is produced and compacted by rolling on the form. The so produced composition is processed as described in example 1. An aluminum foam with a very hard surface made of Al₂O₃ which is chemically inert and mechanically hard as well is produced.

### EXAMPLE 3

Aluminum powder is mixed with 2 wt. % Mg, 10 wt. % Si and 1.5 wt. % titanium hydride powder to obtain a foamable material. The aluminum powder is mixed with compacting additives and is rolled on a form to obtain a first layer. On this layer, a layer of foamable material is produced, which is compacted by rolling. The so produced composition is processed as described in example 1. On the so produced layer, a powder varnish layer is produced by applying a powder varnish material. This layer is baked in a usual varnish oven. Thereby the continuous production of a powder varnished composite material of low weight is possible.

### EXAMPLE 4

Aluminum powder is mixed with 1 wt. % Cu, 8 wt. % Si and 1.5 wt. % Mg and 0.5 wt. % titanium hydride powder to obtain a foamable material.

A mixture of aluminum powder with 12 wt. % Si and 3 wt. % Cu is mixed and rolled on a form to obtain the first layer. On this layer, a layer of foamable material made of a metal powder with a blowing agent is produced which is compacted by rolling and foamed in a continuous furnace at a temperature above 450° C. Thereby, a composite material of low weight is continuously produced.

### EXAMPLE 5

Aluminum powder is dispersed to form a first layer, thereon another layer of the general composition AlSi₁₂ with 5 wt. % TiH₂, is produced and thereon another aluminum powder layer is dispersed in a form. The powder layers are compacted by powder rolling. The so produced rolled material made of three layers is foamed by foaming the intermediate layer into AlSi₁₂ foam by heat radiation. A metal foam with powder rolled aluminum outer layers is obtained thereby. The process is schematically shown in FIG. 5.

### EXAMPLE 6

Aluminum powder is rolled to a first and second layer, optionally with binding material. The so rolled layers are arranged on both sides of a rolled layer made of AlSi₁₂ powder with 5 wt. % TiH₂ powder (optionally with binding material). The powder bands are arranged one on the other and rolled together by another rolling station, and optionally, they are compacted again. The so produced rolled and compacted powder material composed of three layers is foamed by heat radiation and foaming of the intermediate layer into AlSi₁₂ foam. A metal foam with powder rolled aluminum outer layers is produced. The so produced layer bodies have a clearer material limit, between the aluminum outer layers and the aluminum foam, than with the process depicted in the example 5. Thereby outer layers can be produced which are more compacted than the layers indicated in example 5.

As the invention has been described in detail referring to preferred embodiments, the person skilled in the art that understands that many other alternatives and embodiments can be used to carry out the present invention within the limits of the patent claims.

1-18. (canceled)

19. A method for the production of composite bodies with at least one outer layer and a metal foam layer, comprising the steps of:
producing at least one outer layer material powder layer from non-foaming powders, granulates or cuttings, selected from the group consisting of metal or ceramic powder or mixtures of metal or metal alloy powders with alloy additions, mixtures of ceramic powder, structure changing substances, hardening components, like pigments, reflecting materials and self-lubricating materials;
rolling of the at least one outer layer material powder layer;
producing of a layer of a foamable powder mixture containing metal or alloy powder, alloy granules or cuttings and gas-releasing blowing agent;
rolling the foamable powder mixture layer into a foamable layer;
arranging the layers one on the other to form a layer arrangement; and
foaming the foamable powder mixture by heating the layer arrangement with decomposition of the blowing agent, and bonding of the rolled at least one outer layer.

20. The method according to claim 19, wherein the rolling of the at least one outer layer material powder layer comprises individually rolling a plurality of outer layer material powder layers; wherein a plurality of rolled powder layers are produced from foamable material; wherein a predetermined number of layers are superimposed one on the other to form said rolled layer arrangement; and wherein the rolled layer arrangement is subjected to said foaming step.

21. The method according to claim 20, wherein the superimposed layers are subjected to rolling.

22. The method according to claim 19, wherein the production of the rolled powder layers is performed on a form.

23. The method according to claim 19, wherein at least one bonding layer is provided between at least one outer layer material powder layer and the foamable powder layer.

24. The method according to claim 23, wherein the at least one bonding layer is made of a binder material chosen from the group consisting of brazing, flux and anti-oxidable materials.

25. The method according to claim 22, the form is heated.

26. The method according to claim 19, wherein the producing of at least one outer layer material powder layer comprises producing of first and second outer powder layers from different materials, wherein the foamable powder mixture layer is provided between the outer layer powder layers to form said layer arrangement; wherein said layer arrangement is subjected to rolling; and wherein the foam powder mixture layer of said layer arrangement is subjected to said foaming and bonding.

27. The method according to claim 19, wherein the outer layer powder is formed of a material selected from the group consisting of: metals, metal oxides, pigments, ceramic powders.

28. The method according to claim 27, wherein the outer layer powder also contains compacting additives or lubricants.

29. The method according to claim 19, characterized in that the metal powder is selected from the group consisting of aluminum powder with alloy additions, pre-alloyed aluminum alloy powder, a mixture of aluminum powder with compacting additives, and a mixture of aluminum alloy powder with compacting additives.

30. The method according to claim 19, wherein the foamable powder mixture comprises aluminum powder and at least one metal hydride as blowing agent in the amount of between 0.2-1.5 wt. %, 0-50 wt. % Si, 0-3 wt. % magnesium and 0-1 wt. % Cu together with other materials and compacting additives.

31. The method according to claim 19, wherein the foamable powder mixture comprises aluminum powder and at least one metal hydride as blowing agent in the amount of between 0.2-1.5 wt. %, 0-50 wt. % Si, 0-40 wt. % magnesium and 0-1 wt. % Cu together with other materials and compacting additives.

32. The method according to claim 19, characterized in that in at least one powder a net, filament, fibers or hardening components are rolled in.

33. The method according to claim 19, wherein at least one of said powder contains compacting additives.

34. The method according to claim 19, wherein at least one of layers is warmed during rolling thereof.

35. The method according to claim 19, wherein said steps are performed essentially continuously to obtain a product of desired length.

36. The method according to claim 19, wherein at least one of said steps is carried out under a protective gas.

37. Composite body produced by the method of claim 19.
